(19) United States
(12) Patent Application Publication
(10) Pub. No.: US 2005/0265230 A1
(43) Pub. Date: Dec. 1, 2005

(54) Apparatus and method for performing state transition of backup router in router redundancy system

(75) Inventors: Seung-Gu Na, Gyeonggi-do (KR); Yong-Keon Kim, Gyeonggi-do (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/140,074

(22) Filed: May 31, 2005

(30) Foreign Application Priority Data
Jun. 1, 2004 (KR) 2004-39849

(51) Int. Cl. H04L 1/00

(52) U.S. Cl. 370/219

(57) ABSTRACT

Disclosed are an apparatus and a method for performing state transition of a backup router in a router redundancy system comprising a master router and at least one backup router for routing hosts. The method includes the steps of determining if a master router has a fault, and shifting the backup router into a master state if the master router has a fault and replacing a address of the backup router with a address of the master router in such a manner that the backup router operates with the replaced addresses.

### CROSS-REFERENCE TO RELETED APPLICATION

This application claims the benefit under 35 U.S.C. 119(a) of Korean Patent Application entitled “Apparatus And Method For Performing State Transition Of Backup Router In Router Redundancy System” filed in Korean Intellectual Property Office on Jun. 1, 2004 and assigned Serial No. 2004-39849, the entire contents of which are hereby incorporated by reference.

### BACKGROUND OF THE INVENTION

1. Field of the Invention

The present invention relates to a wireless local area network (WLAN). More particularly, the present invention relates to an apparatus and a method for dualizing a default router of hosts in a router redundancy system.

2. Description of the Related Art

A conventional local area network (LAN) is connected to other LANs through at least one router, so that hosts of the conventional LAN, such as personal computers (PCs) or relay entities, can communicate with other hosts provided in the other LANs. The routers receive data packets having destination addresses and transfer the data packets to the destination addresses through a predetermined route capable of fast transferring the data packets to the destination addresses.

In a LAN environment, each host recognizes only one default router in order to communicate with other hosts through external networks. When a host transmits data packets to predetermined destination addresses, the host transfers the data packets to the default router. However, the router may malfunction in the event of a fault such as a power loss, reset, or scheduled maintenance. If such a malfunction occurs in the default router, the host does not communicate with other hosts through the external networks.

In order to solve the above problem, a virtual routing redundancy protocol (VRRP) presented in a request for comments (RFC) 2338 and a hot standby router protocol (HSRP) presented in RFC 2281 allow the hosts to connect to a master router and at least one backup router when the hosts use the default router. The backup routers are called a “backup group” and a router selected from the backup group can be used by the host.

The master router periodically sends a broadcast message to the backup routers in order to notify the backup routers of the available state of the master router. Thus, the backup routers may recognize the available state of the master router based on the broadcast message. If the master router does not send the broadcast message to the backup routers due to an error occurring in the master router, the selected backup router determines that the master router has a fault, so the backup router plays the role of the master router.

For instance, if the backup router does not receive the broadcast message from the master router until three transmission periods has elapsed, the backup router determines that the master router has the fault.

FIG. 1 is a diagram illustrating a network for operating a router redundancy protocol. As shown in FIG. 1, a plurality of hosts 140 through 146 are connected to a master router 120 and a backup router 122 through a LAN 130. Network elements, which access the LAN 130, are connected to an external network through the master router 120 or the backup router 122. For instance, the network elements are connected to an Internet 110 in such a manner that the network elements can communicate with other network elements of the Internet 110.

The master router 120 and the backup router 122 have the same virtual internet protocol (IP) addresses (a.b.c.d) and media access control (MAC) addresses (00:00:5E:00:01:01) and act as routers for the hosts 140 through 146. The hosts 140 through 146 establish the virtual IP address (a.b.c.d) as an IP address of the default router (that is, a default gateway) in order to transfer the packets through the master router 120 if the master router 120 has no fault. If the master router 120 has a fault, the backup router 122 detects the fault of the master router 120 and acts as the default router for the hosts 140 through 146, instead of the master router 120.

As shown in FIG. 1, the master router 120 and the backup router 122 establish virtual IP addresses and MAC addresses based on the same virtual identification (ID)s separately from the IP addresses and MAC addresses. In addition, the hosts 140 through 146 establish the virtual IP address as the IP address of the default gateway. At this time, although data of the hosts are transmitted to the master router 120 and the backup router 122 having the same virtual IDs and virtual IP addresses, only the master router 120 may transmit the data.

As mentioned above, according to the conventional router redundancy protocol, the virtual IDs, virtual IP addresses and MAC addresses must be established with respect to the master router and the backup router, making the structure of the conventional router redundancy protocol complicated. In addition, a virtual IP address field must be formed in a keepalive message, so the size of the keepalive message may increase.

In order to solve the problems occurring in the conventional router redundancy protocol using the virtual IP address of the router, an apparatus and a method are needed that are capable of improving efficiency of the router by minimizing down time without separately establishing the virtual IP address and MAC address when the backup router is operated due to a malfunction of the master router.

### SUMMARY OF THE INVENTION

Accordingly, the present invention is to solve the above-mentioned problems occurring in the prior art, and an object of the present invention is to provide an apparatus and a method for performing state transition of a backup router to a master router when the master router has the fault in a router redundancy system.

Another object of the present invention is to provide an apparatus and a method for operating a backup router by using an internet protocol (IP) address and a media access control (MAC) address of a master router when the master router has the fault in a router redundancy system.

To accomplish these objects, according to an aspect of the present invention, a method for performing state transition of a backup router in a router redundancy system comprising a master router and at least one backup router for routing hosts is provided. The method comprises the steps of determining if a broadcast message is periodically transmitted to the backup router from the master router within a predetermined time, and shifting the backup router into a master state if the broadcast message is not periodically transmitted to the backup router from the master router and replacing an IP address and a hardware address of the backup router with an IP address and a hardware address of the master router in such a manner that the backup router operates with the replaced addresses.

According to another aspect of the present invention, an apparatus for dualizing a default router of hosts in a router redundancy system is provided. The apparatus comprises a first router, which is a master router, for periodically transmitting a broadcast message based on an IP address and a hardware address thereof in order to indicate an available state of the first router, and a second router, which is a backup router, for receiving the broadcast message from the first router and determining if the broadcast message is periodically transmitted thereto from the first router within a predetermined time, wherein the second router is shifted into a master state if the broadcast message is not periodically transmitted to the second router from the first router and replaces an IP address and a hardware address of the backup router with an IP address and a hardware address of the first router in such a manner that the second router operates with the replaced addresses.

### BRIEF DESCRIPTION OF THE DRAWINGS

The above and other objects, features and advantages of the present invention will be more apparent from the following detailed description taken in conjunction with the accompanying drawings, in which:

FIG. 1 is a diagram illustrating a structure of a network for operating a conventional router redundancy protocol;

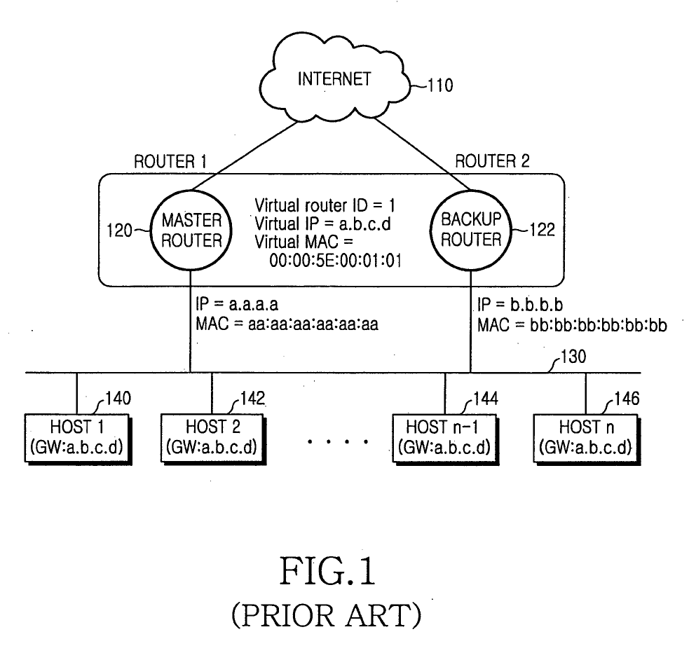

FIG. 2 is a diagram illustrating a structure of a network for operating a router redundancy protocol according to an exemplary embodiment of the present invention; and

FIG. 3 is a flowchart illustrating an operational procedure of a backup router according to an exemplary embodiment of the present invention.

Throughout the drawings, it should be noted that like reference numbers are used to depict the same or similar elements, features and structures.

### DETAILED DESCRIPTION OF EXEMPLARY EMBODIMENTS

Hereinafter, exemplary embodiments of the present invention will be described with reference to the accompanying drawings. In the following detailed description, a detailed description of known functions and configurations incorporated herein will be omitted for clarity and conciseness. In addition, terms used in the following detailed description are defined by taking functions of elements used in the present invention into consideration, so they may vary depending on users, intentions of operators or the practices thereof. Thus, definitions of the terms used in the following description may be determined based on the full context of the present invention.

According to the router redundancy protocol of the present invention, a master router periodically sends a broadcast message to a backup router in order to notify the backup router of the available state of the master router. The broadcast message has a destination address in the form of a multicast address so that all of network elements provided in a local area network (LAN) can receive the broadcast message. At an initial stage, the master router and the backup router are selected based on a priority thereof. That is, a router having a higher priority is selected as the master router. A user can determine the priority for the routers when establishing the routers. If a router has a priority higher than the other router, that router becomes the master router. In addition, if a router has a priority lower than the other router, that router becomes the backup router.

The backup router can determine whether the master router has a fault based on the broadcast message transmitted thereto from the master router. If the backup router does not receive the broadcast message from the master router for a predetermined period of time (for instance, three transmission periods), the backup router determines that the master router has the fault, so the backup router serves as the master router.

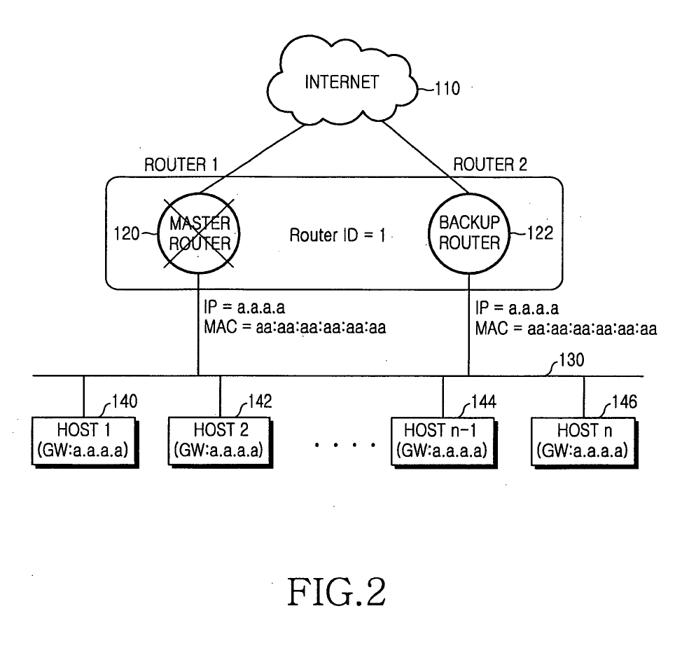

FIG. 2 is a diagram illustrating a structure of a network for operating a router redundancy protocol according to an exemplary embodiment of the present invention.

A master router 120 and a backup router 122 have mutually different internet protocol (IP) addresses and media access control (MAC) addresses. The master router 120 serves as a default router for hosts 140 through 146. The hosts 140 through 146 establish the IP address (a.a.a.a) of the master router 120 as an IP address of the default router, which is a default gateway, in order to transfer the packets through the master router 120 if the master router 120 has no fault.

If the backup router 122 is selected as the master router due to the fault of the master router 120, the backup router 122 replaces its IP address and MAC address with the IP address and MAC address of the master router 120. In addition, the backup router 122 periodically sends the broadcast message while establishing a source address of the broadcast message based on the replaced IP address and MAC address. If the backup router 122 receives an address resolution protocol (ARP) request message from the hosts 140 through 146, the master-state backup router 122 transmits an ARP reply packet to the hosts 140 through 146 while establishing the source address of the ARP reply packet based on the replaced IP address (a.a.a.a).

That is, the backup router currently acting as a master router (i.e., master-state backup router 122) replaces the source IP address and MAC address with the IP address and MAC address of the master router 120, so that the hosts may operate in relation to the master-state backup router 122 while recognizing the master-state backup router 122 as the default router.

Even if the original master router 120 is recovered while the master-state backup router 122 is performing the routing procedure, the master-state backup router 122 continuously performs the routing procedure as the default router. However, if the master-state backup router 122 has a fault while performing the routing procedure, the original master router 120 again serves as the default router instead of the backup router 122.

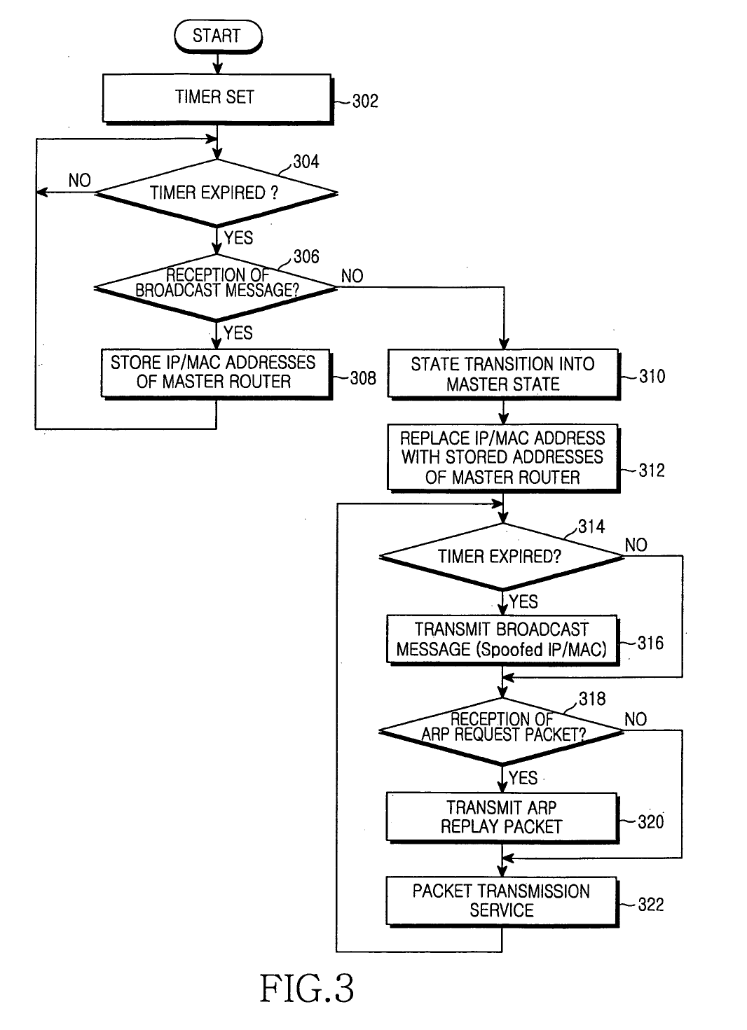

FIG. 3 is a flowchart illustrating an operational procedure of the backup router according to an exemplary embodiment of the present invention.

Referring to FIG. 3, the backup router sets a timer for receiving the broadcast message from the master router at step 302. Then, the backup router waits for a predetermined period of time until the timer expires at step 304. After that, the backup router determines whether the broadcast message is transmitted thereto from the master router before the timer has expired at step 306. If it is determined at step 306 that the backup router has received the broadcast message, the backup router stores the IP address and MAC address of the master router included in the broadcast message at step 308. After that, the backup router resets the timer while maintaining the backup state and repeats steps 304 through 308. However, if it is determined at step 306 that the backup router has not received the broadcast message until the timer has expired, the backup router is shifted into the master state at step 310.

Then, the master-state backup router replaces its IP address and MAC address with the stored IP address and MAC address of the master router at step 312. After that, the master-state backup router waits for a predetermined period of time until the timer expires in order to receive the broadcast message at step 314. If it is determined at step 314 that the timer has not expired, step 318 is performed. In addition, if it is determined at step 314 that the timer has expired, the master-state backup router transmits the broadcast message to a network element though the network while establishing the source address of the broadcast message based on the replaced IP address and MAC address at step 316.

If the master-state backup router receives the ARP request packet from the hosts at step 318, the master-state backup router transmits the ARP replay packet while establishing the source address of the ARP replay packet based on the replaced address at step 320 and performs a packet transmission service at step 322. However, if the master-state backup router does not receive the ARP request packet from the hosts at step 318, step 322 is performed to provide the packet transmission service.

As described above, according to a method for dualizing the default router of the hosts provided in the LAN embodied in the present invention, the backup router plays the role of the master router by using the IP address and MAC address of the master router. In addition, the present invention does not require additional virtual IP/MAC addresses for the routers, so the structure of the router redundancy protocol can be simplified. In addition, since it is not necessary to form the virtual IP address field in the broadcast message, a size of the broadcast message may be reduced, so that the efficiency of the router system can be improved.

While the present invention has been shown and described with reference to certain exemplary embodiments thereof, it will be understood by those skilled in the art that various changes in form and details may be made therein without departing from the spirit and scope of the invention as defined by the appended claims.

1. A method for performing state transition of a backup router in a router redundancy system comprising a master router and at least one backup router for routing hosts, the method comprising the steps of:
determining if a master router has a fault; and
shifting the backup router into a master state if the master router has a fault and replacing a address of the backup router with a address of the master router in such a manner that the backup router operates with the replaced addresses.

2. The method as claimed in claim 1
wherein the fault is estimated that a broadcast message is periodically transmitted to the backup router from the master router within a predetermined time.

3. The method as claimed in claim 1
wherein the address is internet protocol (IP) address or a hardware address

4. The method as claimed in claim 2, further comprising a step of:
storing the address of the master router while maintaining the backup router in a backup state if the broadcast message is periodically transmitted to the backup router from the master router.

5. The method as claimed in claim 1, further comprising a step of:
periodically transmitting the broadcast message by using the master-state backup router while establishing a source address of the broadcast message based on the replaced address.

6. The method as claimed in claim 1, wherein the master-state backup router receives an address resolution protocol (ARP) request message from the hosts and transmits an ARP reply packet to the hosts while establishing a source address of the ARP reply packet based on the replaced address.

7. An apparatus for dualizing a default router of hosts in a router redundancy system, the apparatus comprising:
a first router, which is a master router, for periodically transmitting a broadcast message based on a address thereof in order to indicate an available state of the first router; and
a second router, which is a backup router, for determining if a master router has a fault, shifting the backup router into a master state if the master router has a fault and replacing a address of the backup router with a address of the master router in such a manner that the backup router operates with the replaced addresses.

8. The apparatus as claimed in claim 7,
wherein the fault is estimated that a broadcast message is periodically transmitted to the backup router from the master router within a predetermined time.

9. The apparatus as claimed in claim 7,
wherein the address is internet protocol (IP) address or a hardware address

10. The apparatus as claimed in claim 8, wherein the second router stores the address of the first router while maintaining a backup state if the broadcast message is periodically transmitted to the second router from the first router.

11. The apparatus as claimed in claim 8, wherein the master-state second router periodically transmits the broadcast message while establishing a source address of the broadcast message based on the replaced address.

12. The apparatus as claimed in claim 7, wherein the master-state second router receives an address resolution protocol (ARP) request message from the hosts and transmits an ARP reply packet to the hosts while establishing a source address of the ARP reply packet based on the replaced address.
